(19) United States
(12) Patent Application Publication
(10) Pub. No.: US 2025/0350083 A1
(43) Pub. Date: Nov. 13, 2025

(54) SIDE-COUPLED ACTIVE AND PASSIVE WAVEGUIDES WITH EMBEDDED ELEMENTS FOR IMPROVED LIGHT ABSORPTION

(71) Applicant: IPG PHOTONICS CORPORATION, Marlborough, MA (US)

(72) Inventors: Eugene SCHERBAKOV, Oxford, MA (US); Valentin FOMIN, Oxford, MA (US); Andrey ABRAMOV, Oxford, MA (US); Aleksey DORONKIN, Oxford, MA (US)

(73) Assignee: IPG PHOTONICS CORPORATION, Marlborough, MA (US)

(21) Appl. No.: 19/219,463

(22) Filed: May 27, 2025

Related U.S. Application Data
(63) Continuation of application No. 17/253,687, filed on Dec. 18, 2020.

(51) Int. Cl. H01S 3/067; H01S 3/0804; H01S 3/094; H01S 3/16

(52) U.S. Cl. CPC H01S 3/06737; H01S 3/0672; H01S 3/06733; H01S 3/0804; H01S 3/094007; H01S 3/094019; H01S 3/06745; H01S 3/0675; H01S 3/1603

(57) ABSTRACT

An active waveguide including active and passive rods which have respective polymeric claddings mechanically and optically coupled to one another so as to define a side pumping scheme. One or a plurality of elements are embedded in one of or both active and passive rods and have a refractive index lower than the lowest of refractive indices of the respective active and passive rods at at least 1*10⁻³. The MM core of the active rod includes inner and outer concentric regions with a concentration of light emitters in the outer region being lower than that of the inner region at more than 50% and, a radius of the inner region being at most 92% of that of the outer region. The unabsorbed pump light at the output of the active waveguide constitutes less than 1% of the delivered pump light which in combination with the refractive index of the the embedded elements and selectively doped core regions contribute to laser efficiency of at least 86%.

### CROSS-REFERENCE TO RELATED APPLICATIONS

This application is a continuation of U.S. patent application Ser. No. 17/253,687 filed on Dec. 18, 2020, which is a 371 of international application number PCT/US2019/39748 filed on Jun. 28, 2019, which claims the benefit to provisional application No. 62/691,662, filed on Jun. 29, 2018 which are hereby incorporated by reference herein in its entirety.

### FIELD OF THE INVENTION

This disclosure relates to kW power fiber lasers and amplifiers outputting signal light substantially in a fundamental mode. Particularly, the disclosure relates to an active waveguide including active and pump rods which define a side-pumping configuration, wherein at least one of the rods includes one or more elements embedded in silica cladding and configured to increase pump light absorption in the centrally doped MM core of the active rod. The disclosed laser source demonstrates the reduction of both signal light in the cladding to about 2% and unabsorbed pump light to less than 0.5% which in combination contribute to laser efficiency of at least 86% and wall plug efficiency above 50% at the desired wavelength.

### Prior Art Discussion

Due to increasing energy costs on one hand and regulations on energy efficiency on the other hand, the environmental performance, including the energy efficiency factor, of a variety of laser-based systems has attracted academic and industrial research and development. Considering industrial laser-based tool, the approach for the improvement of the environmental performance includes, among others, three major categories: proper process and machine tool selection, optimized machine tool design, and optimized process control. While the first and last categories are mainly controllable by the process planner or the machine tool operator, the original equipment manufacturer has a dominant influence on the system design which, within the scope of this invention, is a fiber laser source.

FIG. 1 illustrates a typical schematic of fiber laser configured with the resonant cavity which is defined between high and low fiber Bragg gratings (FIGS. 5 and 6 written in respective input and output signal passive fibers 3, 8. Clearly, if not for the shown FBGs, FIG. 1 would be representative of a fiber amplifier. A substantial part of the following description is equally applicable to both the oscillator and amplifier.

The fiber laser of FIG. 1 includes an active double clad signal or active fiber 2 which has a MM core doped with light emitting ions providing amplification of signal light at a signal wavelength λs. The shown schematic utilizes an end pumping technique in which, after the signal light and pump light at wavelength λp≠λs are coupled into a multiplexer 1, they are further launched into the doped core and inner cladding of active fiber 2, respectively. A demultiplexer 9 taps off amplified signal light λs, which is then coupled into signal output passive fiber 8, from unabsorbed pump light λp. Customarily, the pump light, guided in pump light delivery fibers 4 and 7, is launched into opposite ends of the cladding of signal fiber 2 so that it propagates in both directions. However, not all the launched pump light is absorbed.

The unabsorbed pump light renders the fiber laser of FIG. 1 less efficient than its theoretical threshold for several reasons. For example, it affects generation of signal light and results in unsatisfactory gain. Still another reason is damaging of the multiplexer/demultiplexer due to the backreflection of pump light from, for example, splices between opposing ends of respective active fiber 2 and adjacent fibers. Also, unabsorbed pump light propagating in the opposite directions damages pump light sources, FBGs and means for guiding amplified light signal from fiber laser source 10. The above are just a few of many undesirable consequences of the unabsorbed pump light.

FIG. 2 illustrates the power of unabsorbed pump light at wavelength 2p, which propagates through respective multiplexers 1 and 9 into respective pump light fibers 4 and 7, as a function of the total input pump power in fiber laser source 10 of FIG. 1. As can be seen, a portion of unabsorbed pump light remains high which is particularly troubling when the input pump power reaches high power levels. As a consequence, the environmental performance of the fiber laser source of FIG. 1 should be improved.

Pump light absorption can be estimated from the following expression

$${a}_{¸} ∼ {a}_{¸} core \frac{Acore}{Aclad} \qquad ( 1 )$$

where çcore is the core absorption and Acore and Aclad are respective areas of the core and inner cladding of double clad (DC) active fiber 2. It can be seen from the above that the pump light absorption increases with the core absorption, i.e., with increased doping concentration, and/or with the core/clad ratio. However both of above options have limitations. Particularly, the photodarkening effect and background loss set the upper level of rare earth ions concentration. High background losses would result in poor efficiency of the fiber laser sources. This is one reason explaining why the typical slope efficiency in DC active fiber 2 of FIG. 1 is below 70-80%, though the theoretical limit is over 90%.

The other option for pump absorption enhancement—the scaling of the core/clad area—can be achieved by increasing the core diameter with simultaneous reduction of the numerical aperture (NA). However, the core diameter cannot be limitlessly increased because of excitation of multiple high order modes (HOM), provided the core is configured to support multiple modes. The excitation of HOM decreases the quality of output signal light which is often required to be in fundamental mode with M² factor below 1.2 and actually closer to 1.05, with the fundamental mode (FM) having substantially the Gaussian shape of the intensity profile.

The pump light in the inner cladding of active fiber 2 of FIG. 1 propagates in a highly MM regime. Effectively, it is possible to group these modes in two categories: “well absorbed” and “weakly absorbed” modes. The modes of the first category have an axially symmetrical field distribution with a maximum of intensity at the doped core of active fiber 2 and are well absorbed thus efficiently contributing to gain. The modes of the other category have a poor overlap with the doped core and thus do not contribute notably to pump absorption, but these spiral modes carry a significant fraction of pump power making the laser source overall less efficient than it could be if these modes were absorbed.

FIG. 3 illustrates a cross-section of a typical refractive step index profile of DC fiber 2 with core 10 having the highest refractive index and doped with rare earth elements, such as ytterbium (Yb), erbium (Er), neodymium (Nd), thulium (Tm), holmium (Ho) and other known light emitters. The DC fiber 2 further includes an inner cladding, receiving pump light through its end, and outer protective cladding 12 with the lowest refractive index so as to waveguide pump light in the inner cladding.

The pump light at pump wavelength λp, launched into the inner cladding of rod 11 through the opposite ends of fiber 2, consists of meridian rays and skew rays. The meridian rays (not shown) cross core 10 and are effectively absorbed. The skew rays 13, however, propagate in spiral trajectories along the inner cladding practically not crossing core 10 and, thus, without meaningful absorption which further contributes to the unabsorbed pump light portion.

Numerous attempts have been made to rectify the problem with skewed or spiral modes and increase the energy conversion efficiency. Referring to FIG. 4A, DC fiber 2 of FIG. 1 is shown with the radial asymmetry of the interface between inner and outer claddings of the rod. This approach helps scatter some of skew rays 13 such that they cross and absorbed in core 10. FIG. 4B illustrates a different approach in which multiple regions 14 are formed in the cladding of active rod 11. The regions 14 have respective reflective indices different from that of inner cladding 11 so that these regions 14 scatter skew rays 13 in a radial direction through core 10 where at least some of them are absorbed.

Both solutions shown in respective FIGS. 4A and 4B are somewhat effective. However, the alignment of all fibers to be spliced together along a common optical axis, as required by the end pumping technique, is a daunting task often accompanied by unacceptable losses of signal light and unreliable launching of pump light. The structures operative to decrease light losses require sophisticated and complex configurations which are simply economically unjustified thus making the environmental performance of high power fiber lasers and amplifiers unimproved.

FIG. 5 illustrates still another approach providing for the increased pump absorption. The shown structure is based on the side-pumping technique in which active fiber 2 and pump light delivery fiber 15 are in optical (and mechanical) contact along their respective peripheries. An outer cladding 12 wrapped around both rods 11 and 15 is configured with the lowest refractive index precluding decoupling of light out of the inner cladding. It is easy to see that the configuration of FIG. 5 experiences fewer problems associated with light losses and/or structural complexity of devices based on the end-pumping technique of FIGS. 4A and 4B.

Yet the problem with unabsorbed pump light persists. For example, while the pump power used in the side pumping technique can be very high, the cladding area Aclad of expression 1 is also increased since it is the sum of the claddings of respective fibers 2 and 15. Like in the end pumping technique, not all of the pump light at wavelength λp in FIG. 5 is coupled into cladding 11 of active fiber 2 contributing to the increased output power of the unabsorbed pump light. Furthermore, part of the pump radiation coupled into active rod 11 includes spiral modes 13 only partially overlapping core 10 and thus not being adequately absorbed. The unabsorbed pump light may be substantial thus preventing the shown fiber laser from operating at the desired high-level efficiency. Thus, the configuration of FIG. 5, while more efficient than that of FIGS. 4A-4B, still can benefit from more efficient pump light energy convergence into the energy of signal light at wavelength λs.

While the pump light absorption is a major factor contributing to the overall inefficiency of the shown fiber lasers, it is by far not the only factor. As mentioned above, often high quality signal light at wavelength λs, i.e., the light having substantially a single transverse mode (SM), is critical. For example, core 10 of active fiber 2 in FIGS. 4 and 5 is SM if the V parameter at wavelength λs is lower than 2.405 based on the following:

$$V = \frac{2 π r \sqrt{{ncore}^{2} - n c l a {d}^{2}}}{λ s} , \qquad ( 2 )$$

where r—core radius, n_{core} and n_{clad}—refractive indices of core 10 and cladding 11.

Regardless of numerous innovations minimizing excitation of HOM in a MM core, which is designed to operate in substantially a fundamental mode (FM), their total suppression is hardly feasible. Yet a great variety of laser applications are in need for high power single mode laser radiation with a power range beginning at about 1 kW.

The high power requirements necessitate greater core diameters. As a rule, the active fiber is typically coiled in a fiber block FB which requires low bending losses. The latter can be provided if the numerical aperture Δn=n_{core}−n_{clad} is high. For example, in silica fiber with a typical core radius of 10 μm, Δn=2*10³, n_{clad}=1.4495 at signal wavelength λs=1070 nm, the V parameter is 4.47. The fiber with such a high V parameter is MM in which HOMs at signal wavelength λs are amplified. Since all modes in the MM core compete for the same pump energy, the effectiveness of pump energy for generating and amplifying the FM is reduced.

One of the known techniques for minimizing excitation of HOM in a MM fiber includes doping only a central region of MM core 10 of FIGS. 4 and 5. Still another technique is concerned with the fiber geometry. Specifically, bottleneck-shaped fibers have been extensively used to decrease the amplification of HOMs.

Based on the foregoing, a need exists for a fiber laser or amplifier having an active waveguide which includes the signal fiber with a MM core doped with light emitters, and a pump fiber arranged to side-pump the signal fiber, wherein the disclosed fiber laser/amplifier operates close to a maximum theoretical level of efficiency of about 90%.

### SUMMARY OF THE DISCLOSURE

The disclosed active waveguide for fiber lasers and/or amplifiers meets this need. The inventive configuration includes all of the above-disclosed and other features known from the end-pumping arrangement and incorporated in a side pumping technique. Unlike the disclosed device, none of the known to Applicants fiber laser devices with the side-pumping technique operates at the laser efficiency of at least 86% and wall plug efficiency above 50%.

In accordance with one aspect of the disclosed fiber laser device, an active waveguide includes an active rod with a light emitter-doped MM core and a pump light delivery rod. The rods thus arranged represent a side-pumping configuration in which the pump rod delivers MM pump light at wavelength λp, and the active rod amplifies generated signal light at signal wavelength λs which is output in substantially a fundamental mode.

One feature of the disclosed waveguide has at least one of or both rods configured with at least one element embedded in silica cladding. The element has a coefficient of refraction at least 1*10⁻³ lower than that of the delivery rod. The elements effectively reflect spiral modes of MM pump light, which propagate along the inner cladding of the DC fiber without or with a minimal overlap with the MM core, such that the overlap increases. As a result, by comparison with the known prior art, the absorption of pump light in the MM core is increased.

In accordance with a further feature of the disclosed active waveguide, the MM core of the active fiber is configured with an inner region and outer region with the radius of the inner region not exceeding 92% of the radius of the outer region. The concentration of light emitters in the inner region is at least 50% higher than that of the outer core region. This feature allows substantially lower amplification of HOM at the signal wavelength than in the known side-pumping schemes.

The disclosed waveguide incorporating both of the the above-discussed features addresses the problem of the insufficient optical efficiency of kW-level power SM light generation above 87% which allows a fiber laser/amplifier based on the disclosed active waveguide to operate with the overall wall plug efficiency of more than 50%.

The disclosed waveguide further includes an outer clad surrounding both rods and ensuring their optical and mechanical contacts. The outer clad is provided with a coefficient of refraction lower than that of the rods which may have respective indices of refraction substantially the same or different with the refractive index of the active rod being greater than that of the delivery rod. Finally, the outer clad is surrounded by a protective sleeve made from a material with a refractive index higher than that of the outer clad.

In one modification of the disclosed active waveguide, the element or elements are inserted in the active rod. In another embodiment both, active and delivery rods are provided with respective elements. Still in a further embodiment, only the delivery rod includes elements reflecting radial modes of pump light towards the MM core of the active rod.

### BRIEF DESCRIPTION OF THE DRAWINGS

The above and other features and advantages of the disclosed structure are further discussed in the specific description accompanied with the following drawings, in which:

FIG. 1 is a standard schematic of fiber laser source of the known prior art.

FIG. 2 illustrates the dependence of the power of unabsorbed pump light from the input pump light power in the schematic of FIG. 1.

FIG. 3 illustrates a cross-section of the typical DC fiber of the known prior art.

FIGS. 4A and 4B are respective realizations of the DC fiber of FIG. 2 configured to improve absorption of pump light in the known prior art.

FIG. 5 illustrates a typical side pumping arrangement of the prior art.

FIG. 6A-6C illustrate respective modifications of the inventive active waveguide.

FIG. 6D is a longitudinal side view of bottleneck-shaped active and passive rods coupled together along the pump light coupling region of the disclosed active waveguide of FIGS. 6A-6C.

FIGS. 7A, 7B, 7C and 7D illustrate respective doping profiles of the active rod configured in accordance with the invention.

FIGS. 8A and 8B illustrate laser efficiency of inventive and known active waveguides at respective output powers of signal light and the percentage of unabsorbed pump light and signal light in the cladding of respective known and inventive active waveguides at a given signal wavelength.

### SPECIFIC DESCRIPTION

Reference will now be made in detail to the disclosed system. Wherever possible, same or similar reference numerals are used in the drawings and the description to refer to the same or like parts or steps. The drawings are in simplified form and are far from precise scale.

The disclosed structure is specifically configured to meet the heightened requirements for efficiency of MM fiber laser provided with a side-pumping arrangement and outputting kW-level signal light in substantially a fundamental mode. It distinguishes from the known prior art by a new combination of known elements which decreases the unabsorbed pump light below 0.5% and signal light in the cladding to about 2% thus increasing the laser efficiency to 86-90%.

The higher efficiency of a laser always translates into the lower consumption of power, has a less devastating environmental impact, and provides the increased safety of the maintenance personnel, to name just a few advantages. Thus it is not unusual when the product, showing improvement of a fraction of percent may radically change the marketability of the improved product. What could be considered trivial in terms of enhanced product characteristics outside the targeted industry may be viewed as pioneering by ordinary and not so ordinary skill workers in this particular industry.

The disclosed configuration is a good example of how known in principle elements incorporated in a new structure render this structure to be on a technological cutting edge. The disclosed MM fiber laser/amplifier with signal light output in substantially a single, fundamental mode (FM) is based on a side-pumping technique in which active and passive pump rods are arranged in a side-to-side arrangement. At least one of the active and pump rods is provided with elements having a refractive index lower than that of the surrounding cladding to increase mixing and absorption of pump modes. However, the utilization of the elements, well known from the end pumping schemes, in a side-pumping arrangement is not obvious. It is well known by one of ordinary skill in the fiber laser arts that mode mixing in active fibers with an asymmetric core is improved. In the side-pumping arrangement of the disclosed type the MM core is asymmetrically located. That is why to the best of Applicants' knowledge and belief the attempts of inserting any additional means into active rods for the enhancement of mode mixing in the side pumping arrangement have not been reported. As to the passive rod in the disclosed structure, again to the best of Applicants' knowledge have not known and for a good reason. Typically the active waveguide including side by side coupled active and pump rods are coiled in the fiber blocks. The applicants tend to believe that pump modes in the coiled fiber deform which worsens the absorption of pump modes. However, typically at the output of fiber block housing a kW-level side-pumped fiber laser/amplifier unabsorbed pump light constitutes very few percent of the pump light delivered to the active rod. This amount of unabsorbed pump light is generally acceptable and further improvement may somewhat negatively affect the overall efficiency of the laser. In contrast, the disclosed structure is configured to increase the laser efficiency.

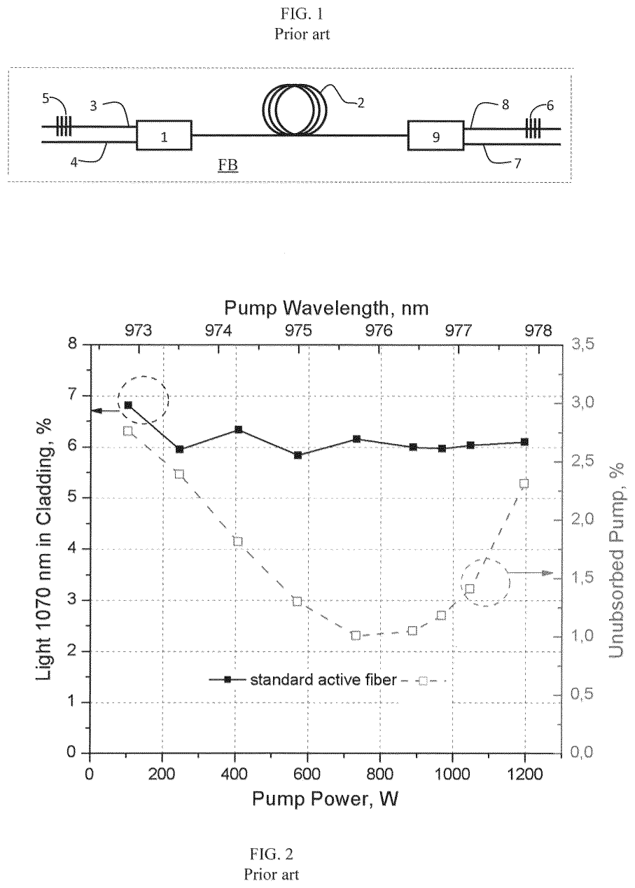

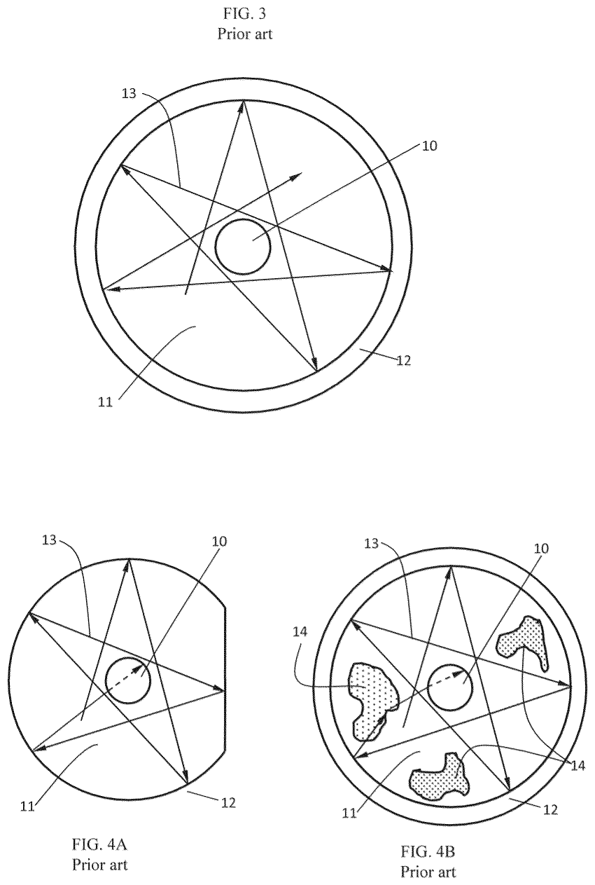

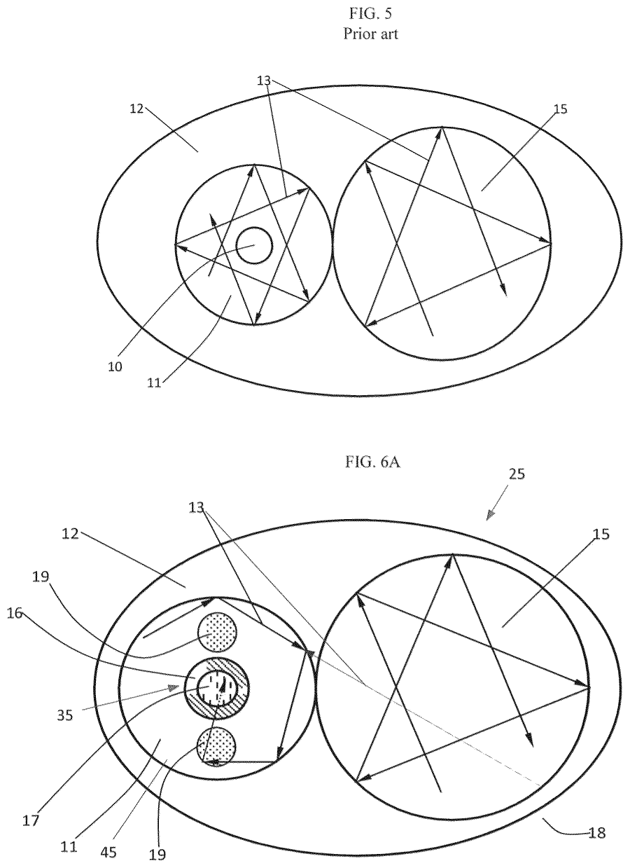

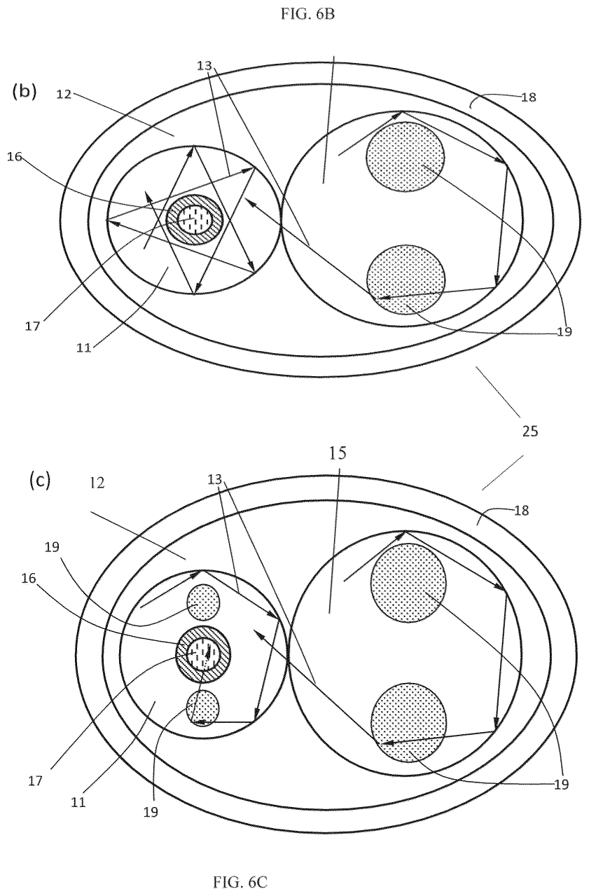

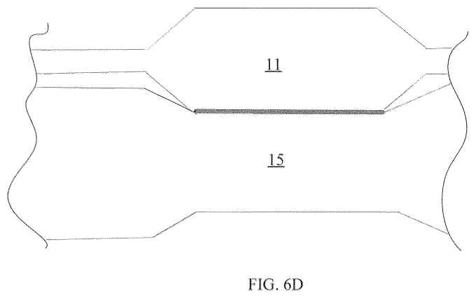

With the above in mind, the following description discloses the inventive configuration drastically improving the laser efficiency. FIG. 6A shows an active waveguide 25 of the schematics of FIG. 1 is typically coiled in fiber block FB. The illustrated active waveguide 25 is representative of a side-pumping arrangement including active fiber rod 11 with a MM core 35 which has a central axis A and is doped with any of the known light emitters or a combination thereof. For example, the light emitter may be the ions of ytterbium (Yb) generating signal light at, for instance, 1070 nm wavelength λs.

The active waveguide 25 further includes passive rod 15 extending along its central axis B and delivering MM pump light at pump wavelength λp, for example 976 nm and having an index of refraction at most equal to that of active rod 11. The outer cladding 12 with the index of refraction lower than that of rods 11 and 15 keeps active and passive rods 11, 15 in mechanical and optical contact along the adjoined peripheries of respective rods. The coupled peripheries of the active waveguide define a coupling stretch over the length of which pump light keeps crossing the interface between the rods so as to be absorbed in the MM core 35. As discussed above, not all pump light is coupled into active rod 11, and even the coupled pump light has spiral modes 13 not adequately overlapping the central region of MM core 35 because, as known to one of ordinary skill, these modes propagate along a path 16 without crossing central core region 17. Hence not all the energy of the pump light is converted into that of the signal light affecting thus laser efficiency and output power of signal light.

In accordance with one aspect of the inventive concept, one or more elements 19 are inserted into the host material of cladding 45, such as silica, of active rod 11. Having the refractive index lower than that of cladding 45, elements 19 are configured to redirect spiral modes 13 of pump light towards core 35 and improve the absorption of these modes. To prevent any undesirable load on core 35, elements 19 are made of silica doped with ions of fluoride (F) and possibly boron (B) which lower the index of refraction ne of elements 19 below index n_{c11} of cladding 45 at at least 1*10⁻³. The latter limitation is critical for effective mode mixing leading to the increased laser efficiency. In contrast, the prior art teaches that this difference between these coefficients should not exceed 1*10⁻³, because otherwise the polarization properties of the core guided light may be affected. Yet, the disclosed active waveguide, if necessary, can be configured with polarization-maintenance rods.

A further feature providing the improved environmental performance of the disclosed waveguide includes partial doping of MM core 35 of active rod 11 with light emitters. Depending on the desired transverse mode different regions of core 35 may be more or less doped. In light of the present disclosure which is concerned with a fundamental transverse mode, it is a relatively small central region 17 which has a higher concentration of ions of rare earth elements than that of an outer core region 16. The latter may not be doped with light emitters at all or have their concentration lower than that of central core region 17 at 50% or less. Such a selective doping reduces the use of pump energy for amplification of HOM propagating close to the periphery of core 35. Geometrically, central core region 17 has a radius of at most 92% of that of outer core region 16. With the above disclosed parameters of the MM core, more pump energy goes on the generation and amplification of the FM.

FIG. 6B illustrates another embodiment of active waveguide 25 based on the inventive concept. Similar to FIG. 6A, waveguide 25 is realized as the side pumping arrangement including active and passive rods 11 and 15, respectively. In contrast to the embodiment of FIG. 6A, this embodiment features element or elements 19 inserted in passive rod 15. The insertion of elements 19 in any of rods 11 and 15 is done by preliminary drilling the desired number of channels in the rod which later receive respective elements 19. The elements 19 are each configured with refractive index ne lower than index nc15 of rod 15 at at least 1*10³. The pump light and particularly skew rays are directed towards active rod 11 in such a manner that the overlap between coupled into rod 11 spiral pump modes 13 and MM core 35 is increased. The MM core of waveguide 25 is configured similarly to that of FIG. 6A.

FIG. 6C illustrates yet another realization of the inventive concept including a combination of the inventive features of FIGS. 6A and 6B. Particularly, active and passive rods 11, 15 respectively each are provided with elements 19 disclosed above. The MM core 35 has two or more annular regions as discussed above in regard to respective FIGS. 6A and 6B. The skew rays 13 of pump light propagate in passive rod 15 along path 22 which is known to one of ordinary skill to be helical. The elements 19 are embedded along path 22 so as to redirect at least some of these rays to active rod 11 through a coupling region between two directly bonded peripheries of respective rods 11, 15. The coupled skew modes continue the propagation in active rod 11 along path 16 without crossing central core region 17. However, spaced elements 19 are positioned along path 16 to redirect skew rays so that they cross central core region 17.

The active waveguide of FIGS. 6A-6C may be provided with a third cladding 18 (shown in FIGS. 6 B and C) which serves as a shield from external mechanical loads. However, third cladding 18, shielding cladding 12 from physical damages, may have a refractive index greater than the claddings of respective active and passive rods.

In summary, the laser efficiency of the schematics of FIG. 1 including the side pumping arrangement with the inventive active waveguide is increased at least to 86% for the following structural particularities:
Elements 19 increasing pump light absorption; and
Selectively doped MM core of active rod 11 decreasing amplified HOMs at the signal wavelength.

In addition to the main structural innovation in the side pumping arrangement of the disclosed active waveguide, a few additional features are incorporate in any of the above disclosed embodiments and contribute to unprecedentedly high efficiency for side-pumped fiber lasers/amplifiers. The shape of active rod 11 may have a bottleneck shaped cross section along the optical axis of this rod with one or both ends each having a diameter smaller than that of central part. The passive rod 15 may be configured with a central part smaller than that of one or opposite ends. The bottleneck-shaped rods 11 and 15 may be incorporated in schematics of FIGS. 6A-6C together or either of them may be paired with the other uniformly shaped rod.

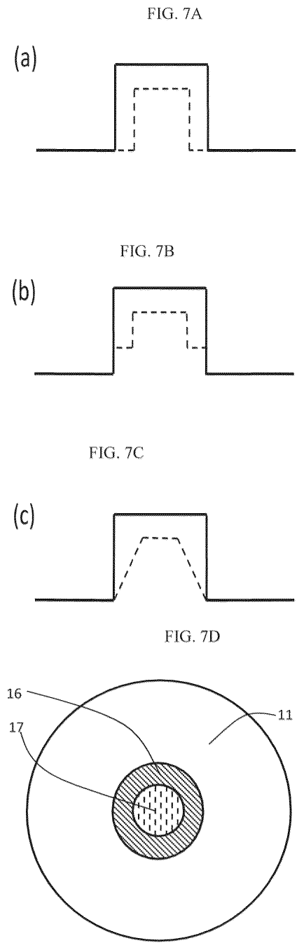

FIGS. 7A-7D illustrate respective configurations of the refractive step index profile of the active rod and dopant profile provided in its MM core. FIGS. 7A and 7D show a uniformly formed doped central core region 17 of the core and the undoped outer core region 16. FIG. 7B illustrates the dopant concentration of the central core region to be substantially greater than that of outer core region 16. FIG. 7C illustrates a frustoconically shaped dopant profile narrowing towards the center of the core from the interface between the core and cladding.

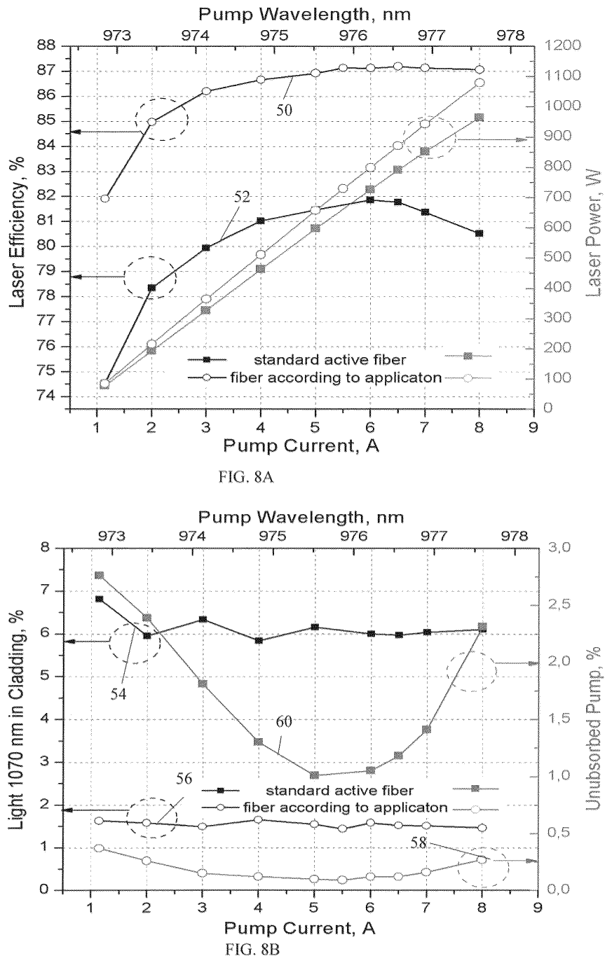

Numerous experiments with the above-disclosed active waveguide have been and continue to be conducted amounting to a substantial date. The advantages of elements 19 are clearly seen in FIGS. 8A and 8B. The unabsorbed pump power at the output of fiber block FB of FIG. 1 is sharply reduced from 21 W at 1200 W total input pump power with the prior art active rod to about 3.5 W in the inventive structure.

Referring to FIG. 8A, black curve 50 represents the maximum laser efficiency of 87.2% in the inventive structure compared to about 81% on a black curve 52 representing the configuration of the known prior art at the output power of FM signal light at a 1070 nm signal wavelength of 900 W and 977 nm pump wavelength.

The data shown in FIG. 8A is a direct result of the structural innovation of the inventive active waveguide including the reduced unabsorbed pump light and signal light in the cladding as shown in FIG. 8B. Only about 1.5% of signal light is detected in the cladding, as indicated by curve 56 (FIG. 8B). In contrast, the prior art structure operates with at least 6% of the unwanted signal light in the cladding which can be seen on curve 54. Similarly, the unabsorbed pump light at the output of the fiber block FB in the inventive structure is between 0.1.-0.3% as shown by curve 58 of FIG. 8B, whereas the prior art device has about 2% and higher of the unabsorbed pump light at the maximum laser efficiency as illustrated by curve 60.

Accordingly, it is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

The invention claimed is:

1. An active waveguide including active and passive rods which are optically and mechanically coupled to one another in a side-pumping scheme, the passive rod delivers pump light to the active rod, and the active rod is provided with a multimode (MM) core configured to amplify a generated signal radiation, and wherein the improvement comprises:
one or more elements embedded in the active rod or passive rod or both and having a refractive index lower than that of material of the rods, which surrounds the elements, at at least 1*10⁻³;
the MM core of the active rod including
inner and outer concentric regions with a concentration of light emitters in the outer region being lower than that of the inner region at more than 50%, and
a radius of the inner region being at most 92% of that of the outer region,
wherein the unabsorbed pump light at the output of the active waveguide constitutes less than 1% of the delivered pump light which in combination with the refractive index of the embedded element and selectively doped core regions contribute to laser efficiency of at least 86%.

2. The active guide of claim 1 further comprising at least one outer cladding surrounding respective active and passive rods so as to keep the passive and active rods in the mechanical and optical contacts, wherein the one outer cladding has a refractive index lower than the lowest refractive index of claddings of respective active and passive rods.

3. The active waveguide of any of the above claims further comprising a plurality of the elements embedded in the cladding of the active rod.

4. The active waveguide of any of claims 1 or 2 further comprising a plurality of the elements embedded in the cladding of the passive rod.

5. The active waveguide of any of claims 1 and 2 further comprising a plurality of the elements embedded in the claddings of respective active and passive rods.

6. The active waveguide of any of the above claims, wherein the claddings of respective active and passive rods have central parts coupled together to define a coupling path for the pump light into the active rod, the central part of the passive rod having a diameter smaller than that of opposite ends thereof.

7. The active waveguide of any of the above claims, wherein the claddings of respective active and passive rods have central parts coupled together to define a coupling path for the pump light into the active rod, the central part of the active rod having a greater diameter than that of opposite ends thereof.

8. The active waveguide of claim 2 further comprising a protective cladding surrounding the one outer cladding.

9. The active waveguide of any of the above claims, wherein the claddings of respective active and pump rods have central parts coupled together to define a coupling path for the pump light into the active rod, the central part of the pump rod having a diameter smaller than that of opposite ends thereof while the central part of the active rod being greater than that of opposite ends thereof.

10. The active waveguide of claim 1, wherein the outer core region of the MM core is free from light emitters.
